(19) United States
(12) Patent Application Publication
(10) Pub. No.: US 2008/0173270 A1
(43) Pub. Date: Jul. 24, 2008

(54) Fuel injection device including plasma-inducing electrode arrays

(75) Inventors: Don M. Coates, Santa Fe, NM (US); Louis A. Rosocha, Los Alamos, NM (US)

Correspondence Address: RAUSCHENBACH PATENT LAW GROUP, LLC, P.O. BOX 387, BEDFORD, MA, 01730, US

(73) Assignee: Perriquest Defense Research Enterprises LLC, Meriden, CT (US)

(21) Appl. No.: 11/880,919

(22) Filed: Jul. 25, 2007

Related U.S. Application Data
(63) Continuation-in-part of application No. 11/543,400, filed on Oct. 5, 2006.
Application No. 11/543,400 is a continuation-in-part of application No. 11/218,792, filed on Sep. 1, 2005.

(51) Int. Cl. F23Q 13/00; F02C 7/266; F02P 23/04

(52) U.S. Cl. 123/143 B; 60/39.821; 431/264

(57) ABSTRACT

A plasma assisted combustion device includes a body formed of a dielectric material that defines a conical-shaped plasma chamber. A ground electrode is positioned in the plasma chamber. A hot electrode is energized with a high voltage that strikes a plasma discharge in a gap between the ground electrode and an outer surface of the plasma chamber. A fuel injector is positioned proximate to the conical chamber. The fuel injector includes a nozzle that converts a liquid fuel into an aerosolized high molecular weight fuel that sprays into the plasma chamber. The plasma in the gap cracks the aerosolized high molecular weight fuel into at least some lower molecular weight fuel and creates at least some free radicals and/or excited-state species.

### RELATED APPLICATION SECTION

This patent application is a continuation-in-part of U.S. patent application Ser. No. 11/543,400, filed Oct. 5, 2006, and entitled “Fuel Injection Device Including Plasma-Inducing Electrode Arrays,” which is a continuation-in-part of U.S. patent application Ser. No. 11/218,792, filed Sep. 1, 2005, and entitled “Fuel Injector Utilizing Non-Thermal Plasma Activation.” The entire specifications of U.S. patent application Ser. Nos. 11/543,400 and 11/218,792 are incorporated herein by reference.

### FEDERAL RESEARCH STATEMENT

This invention was made under CRADA number LA05C10524. The Government may have certain rights in this invention.

### BACKGROUND OF THE INVENTION

The methods and apparatus of the present invention relate to fuel injection devices and other fuel activation devices for internal combustion engines and other types of combustion devices. These fuel injection and other fuel activation devices create electrical discharges or plasmas in a gaseous medium to activate a fuel. Fuel injection using non-thermal plasmas generates electrons that are “hot,” while the ions and neutral species are “cold,” which results in minimal waste enthalpy being deposited in a process medium (i.e., gas/aerosol/vapor stream). This is in contrast to thermal plasmas, where the electron, ion, and neutral-species energies are all “hot” and in thermal equilibrium. Thermal plasmas are undesirable for some applications because they generate considerable waste heat and this waste heat can be deposited in the process medium.

U.S. Pat. No. 6,606,855 to Kong et al., entitled “Plasma Reforming and Partial Oxidation of Hydrocarbon Fuel Vapor to Produce Synthesis Gas And/Or Hydrogen Gas,” teaches methods and apparatus for treating fuel vapors with thermal or non-thermal plasmas to promote reforming reactions between the fuel vapor and re-directed exhaust gases. These reactions produce carbon monoxide and hydrogen gas, partial oxidation reactions between the fuel vapor and air to produce carbon monoxide and hydrogen gas, or direct hydrogen and carbon particle production from the fuel vapor. One disadvantage of the methods and apparatus described in Kong et al. is that the hydrocarbon gases are formed with carbon particles (i.e. soot). Introduction of carbon particles into a working engine is highly undesirable because carbon particles are difficult to combust, can cause pre-ignition, and can cause engine damage.

U.S. Pat. No. 6,322,757 to Cohn et al., entitled “Low Power Compact Plasma Fuel Converter,” also teaches the conversion of fuel, particularly into molecular hydrogen (H2) and carbon monoxide (CO). The apparatus described in Cohn et al. also generates high levels of soot. In addition, the apparatus described in Cohn experience electrode erosion because the apparatus employs a hot-arc thermal plasma, rather than a low-temperature, non-thermal plasma.

### BRIEF DESCRIPTION OF THE DRAWINGS

The aspects of this invention may be better understood by referring to the following description in conjunction with the accompanying drawings. Identical or similar elements in these figures may be designated by the same reference numerals. Detailed description about these similar elements may not be repeated. The drawings are not necessarily to scale. The skilled artisan will understand that the drawings, described below, are for illustration purposes only. The drawings are not intended to limit the scope of the present teachings in any way.

FIG. 1A illustrates a cross-sectional view of one embodiment of a plasma assisted combustion device according to the present invention.

FIG. 1B illustrates a top-view of the plasma assisted combustion device according to the present invention that is described in connection with FIG. 1A.

FIG. 2A illustrates a cross-sectional view of a second embodiment of a plasma assisted combustion device according to the present invention.

FIG. 2B illustrates a top-view of the plasma assisted combustion device described in connection with FIG. 2A.

FIG. 3 illustrates a top-view of an array of plasma assisted combustion devices according to the present invention.

FIG. 4 illustrates a cross-section of a turbine engine that uses the plasma assisted combustion device of the present invention.

### DETAILED DESCRIPTION

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

It should be understood that the individual steps of the methods of the present invention may be performed in any order and/or simultaneously as long as the invention remains operable. Furthermore, it should be understood that the apparatus and methods of the present invention can include any number or all of the described embodiments as long as the invention remains operable.

The present teachings will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teachings herein will recognize additional implementations, modifications, and embodiments, as well as other fields of use, which are within the scope of the present disclosure as described herein.

Combustion-based engines, such as aircraft jet turbines, ground based turbines that produce electric power, internal combustion engines, such as engines used in trucks and automobiles, and other engines produce emissions that are considered detrimental to the earth's climate, in particular, oxides of nitrogen (NOX). Therefore, it is highly desirable to use fuel injection devices that reduce NOX emissions.

Fuel injection devices according to the present invention use Plasma Assisted Combustion (PAC), realized through a silent-discharge, dielectric-barrier non-thermal plasma (NTP) reactor. Plasma assisted combustion is described in U.S. patent application Ser. No. 11/218,792, filed Sep. 1, 2005, and entitled “Fuel Injector Utilizing Non-Thermal Plasma Activation” which is incorporated herein by reference. Plasma assisted combustion generates energetic electrons and other highly reactive chemical species (such as free radicals) in a fuel that feeds internal combustion engines, or other combustion devices employing fuel injectors.

The plasma assisted combustion “cracks” long, complex-chain hydrocarbon fuels into lower molecular weight fuels. The plasma assisted combustion also creates short-lived “free radical” species. It has been shown that lower molecular weight fuels and free radicals promote better overall combustion. In addition, it has been shown that lower molecular weight fuels and free radicals significantly enhance “lean-burn” mode combustion, which is a fuel lean, air rich mode of combustion. Operating in the “lean burn” mode reduces the production of NOX pollutants by reducing the temperature of the combustion process and thus reducing the oxidation of nitrogen in the combustion mixture.

In addition, plasma assisted combustion improves the efficiency of combustion in these engines by achieving a more complete combustion. It has been demonstrated that more complete combustion results from combusting relatively low molecular weight fuels. Also, cracking fuels into lower molecular weight fuels allows engines to burn “lower grade” fuels, which are generally less expensive and more abundant. Thus, plasma assisted combustion provides for greater flexibility in the type of fuel used in these engines.

More specifically, a plasma assisted combustion device according to the present invention first converts a liquid fuel into a dispersed mist, vapor, or aerosolized fuel, and then injects the aerosolized fuel into at least one plasma-inducing electrode that forms a non-thermal plasma. The at least one plasma-inducing electrode cracks the aerosolized fuel into lower molecular weight fuels and then actives “free radical” species in order to reduce emissions and to improve the fuel efficiency of combustion engines.

Some features of the plasma assisted combustion device of the present invention are that the resulting combustion has relatively low harmful exhaust emissions and has relatively high fuel efficiency. The non-thermal plasma generates energetic electrons, which then aid in the formation of free radicals. The resulting free radicals are highly reactive chemical species that promote combustion reactions. The enhanced combustion greatly reduces soot production and production of undesirable oxidative reactions that were described in Kong et al.

Another feature of the plasma assisted combustion device of the present invention is that it provides improved protection against undesirable electrical discharges between the “hot” (high voltage) electrode and the ground surfaces. The protection against undesirable electrical discharges is accomplished at least in part by positioning possible arcing surfaces behind high dielectric strength materials. The plasma assisted combustion device also physically separates the possible arcing surfaces far enough to further reduce the probability of establishing an undesirable electrical breakdown condition. In addition, the plasma assisted combustion device is designed to provide a longer pathway for arcing from the excited plasma gases to the ground surfaces.

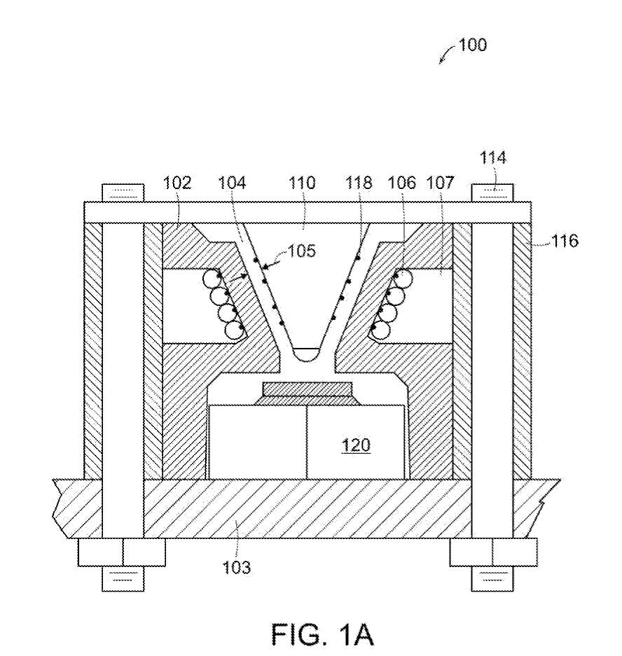

FIG. 1A illustrates a cross-sectional view of a plasma assisted combustion device 100 according to the present invention. The plasma assisted combustion device 100 includes a body 102 that defines a conical-shaped chamber 104 in a center region. In many embodiments, the body 102 is mounted on a housing or bracket 103. The body 102 is formed of a high-dielectric strength material that prevents undesirable electrical discharges. Numerous types of high-dielectric strength materials can be used.

The plasma assisted combustion device of the present invention can be dimensioned to provide both a sufficient high voltage breakdown resistance necessary to prevent undesirable arcing and a physical size and volume that fit into common internal combustion engines. A relatively small shape and volume is achieved, at least in part, by using a body 102 formed of a high-dielectric strength ceramic material (although other materials can be employed).

For example, in one embodiment, the high dielectric strength material forming the body 102 is a glass/mica machinable ceramic, such as a Macor® machinable glass ceramic. The high-dielectric strength material forming the body 102 can also be alumina, porcelain, glass, a high-temperature plastic, such as Teflon®, a polyimide, or a polyamide. Other types of high-dielectric strength materials, such as some dielectrics commonly used in electronic capacitors are suitable. For example, the high-dielectric strength material can be one of two high-dielectric strength materials manufactured under the DuPont Company trade name of Mylar® and Kapton®. In addition, some high temperature rubber compounds can be used for the high-dielectric strength material.

A “hot” (high voltage) electrode 106 is positioned around the conical-shaped chamber 104 defined by the body 102. The hot electrode 106 is a high voltage electrode that is formed of a high conductivity material. During normal operation, the hot electrode 106 is energized with approximately 10 kV AC (although other voltages and electrical waveshapes can be employed).

The hot electrode 106 is shielded with a dielectric material and is positioned to minimize the probability of creating an undesirable electrical discharge to ground. In some embodiments, the hot electrode 106 is positioned in the body 102 so that the body 102 envelopes the hot electrode 106. In other embodiments, the hot electrode 106 is wrapped around the body 102 in one or more sleeves.

A conical-shaped ground electrode 110 is positioned in the conical-shaped chamber 104 in the center of the body 102 so as to form a gap between an outer surface of the body 102 and the ground electrode 110. In some embodiments, the conical-shaped ground electrode 110 is a solid or a partially solid structure. In other embodiments, the conical-shaped ground electrode 110 is formed of a wire mesh material.

The conical-shaped ground electrode 110 can be formed of a stainless steel alloy, tungsten, a tungsten alloy, or one of a number of other refractory metals and refractory metal alloys that are resistant to erosion in a plasma environment. In addition, the ground electrode 110 can be formed of a carbon-based composite material. For example, the ground electrode 110 can be formed of a carbon nanotube material, or a graphitic surface material. Such materials are particularly resistant to erosion in plasma environments.

The gap 105 defines a plasma chamber. In some embodiments, the gap 105 has an approximately uniform gap width. For example, in some embodiments, the gap 105 is in the range of 0.5 mm to 20 mm. In some embodiments, the gap 105 is dimensioned to reduce a probability of generating an undesirable electrical discharge between the hot electrode 106 and the ground electrode 110.

A support structure is used to suspend the conical-shaped ground electrode 110 in the center of the body 102 so as to form a gap between an outer surface of the body 102 and the ground electrode 110. The support structure also provides a direct ground connection for the ground electrode 110. In some embodiments, the support structure is designed to increase the discharge path length from the plasma to at least one of the ground electrodes 110 and the support structure.

In the embodiment shown in FIG. 1A, the conical-shaped ground electrode 110 is held by a support structure comprising posts or rods 114 that are attached to the bracket 103. The rods 114 are coupled to the ground electrode 110 so as to suspend the ground electrode 110 above an outer surface of the chamber 104 thereby forming the gap 105 between the ground electrode 110 and the outer surface of the body 102. The rods 114 are at ground potential so as to electrically ground the ground electrode 110.

In many embodiments, these rods 114 are electrically grounded to the chassis of the engine. The rods 114 are insulated so as to prevent undesirable electrical discharges. In one embodiment, the rods 114 are insulated with an insulating sleeve 116. In some embodiments, the insulating sleeve 116 is formed of alumina. In some embodiments, potting material 107 is used to further insulate the hot electrode 106 and to hold the assembly together. For example, the potting material 107 can be a high temperature ceramic casting compound. A suitable high temperature ceramic casting compound is available from Morgan Technical Ceramics (McDaniel Advanced Ceramics).

In one embodiment, the ground electrode 110 includes at least one surface structure 118 that is designed to locally enhance the concentration of the electric field generated by the hot electrode 106 so to increase the probability of igniting the plasma. In various embodiments, the surface of the ground electrode 110 is a roughened surface or a surface that includes protrusions that form locally intense electric fields. For example, the ground electrode 110 can be formed of a stainless steel material that is machined to have sharp projections. In some embodiments, at least one surface structure is included that locally increases the electric field generated by the hot electrode 106 so as to reduce the probability of generating an undesirable electrical discharge.

A fuel injector 120 is positioned below the conical-shaped chamber 104 so as to provide a spray of fuel into the chamber 104 when activated. Suitable fuel injectors are commercially available from manufacturers, such as Delphi and Bosch. Other manufactures sell suitable fuel injectors for aircraft and watercraft. The fuel injector 120 converts a liquid fuel into a dispersed mist, vapor, or aerosolized fuel for combustion. The hot electrode 106, ground electrode 110 and the fuel injector 120 are positioned so that there is a seam-free barrier to “line of sight” electrical discharges from the hot electrode 106 to the ground electrode 110 and to the fuel injector 120.

FIG. 1B illustrates a top-view of the plasma assisted combustion device 100 according to the present invention that is described in connection with FIG. 1A. The ground electrode 110 and the conical-shaped chamber 104 are shown in the center of the plasma assisted combustion device 100 with the gap 105. The top-view also shows a step 150 that is machined into the top surface of the body 102. The purpose of the step 150 is to increase the path length of the plasma to reduce the probability of establishing an undesirable electrical discharge. One feature of the plasma assisted combustion device 100 is that it can have a shape and a volume that fits in commonly used internal combustion engine.

An electrical transmission line 152 is electrically coupled to the hot electrode 106 (FIG. 1) via a feed through in the body 102. The electrical transmission line 152 feeds power to the hot electrode 106. An insulating sleeve 154 is positioned around the transmission line 152 close to the body 102 in order to prevent undesirable electrical discharges from forming.

A power supply 156 is electrically coupled to the transmission line 152 that feeds power to the hot electrode 106 (FIG. 1A) and to the ground electrode 110 so as to power the plasma assisted combustion device 100. The power supply 156 generates a high voltage that is sufficient to break down the fuel and cause an electrical discharge. In one embodiment, the power supply 156 generates an alternating current voltage that is in the range of about 1 kV to 50 kV with a frequency that is in the range of about 10 Hz-20 kHz. The alternating current waveform can be a sine wave, a square wave, or some complex waveform.

Referring to both FIGS. 1A and 1B, in one embodiment, a method of plasma assisted combustion includes forming a gap 105 in a plasma chamber between a conical-shaped ground electrode 110 and a hot electrode 106. The ground electrode 110 and the hot electrode 106 are electrically insulated so as to reduce a probability of generating an undesirable electrical discharge. In one embodiment, the method includes insulating at least one of the hot electrode 106 and the ground electrode 110 with high dielectric ceramic materials to reduce the probability of generating an undesirable electric discharge. Also, in one embodiment, the method includes positioning at least one of the hot electrode 106 and the ground electrode to reduce a probability of generating an undesirable electric discharge.

A hot electrode 106 is energized with a high voltage that strikes a non-thermal plasma discharge in the gap. In one embodiment, the method includes positioning at least one of the hot electrodes and the ground electrode to increase a probability of striking the plasma discharge. An aerosolized high molecular weight fuel is injected into the gap. The plasma in the gap cracks the aerosolized high molecular weight fuel into lower molecular weight fuel and creates free radicals. The lower molecular weight fuel and free radicals are then mixed with air. The mixture of lower molecular weight fuel, free radicals, and air is then ignited. In some embodiments, the method further includes compressing the air that is mixed with the lower molecular weight fuel and free radicals.

In some embodiments, the method includes increasing or maximizing the fuel efficiency by properly selecting at least one of the voltage applied to the hot electrode, the dimensions of the gap, and the amount of air mixed with the lower molecular weight fuel and the free radicals. Also, in some embodiments, the method includes decreasing or minimizing undesirable emissions by properly selecting at least one of the voltages applied to the hot electrode, the dimensions of the gap, and the amount of air mixed with the lower molecular weight fuel and the free radicals.

The method of the present invention results in a higher flame propagation rate. The term “flame propagation rate” is defined herein to mean the speed of travel of ignition through a combustible mixture. A higher flame propagation rate causes more complete combustion because the fuel is cracked into smaller compounds and because free radicals are generated. Achieving more complete combustion allows the use of a more diluted combustion mixture having a relatively high fraction of air, which increases the fuel efficiency of the engine. In addition, the more complete combustion reduces unwanted emissions.

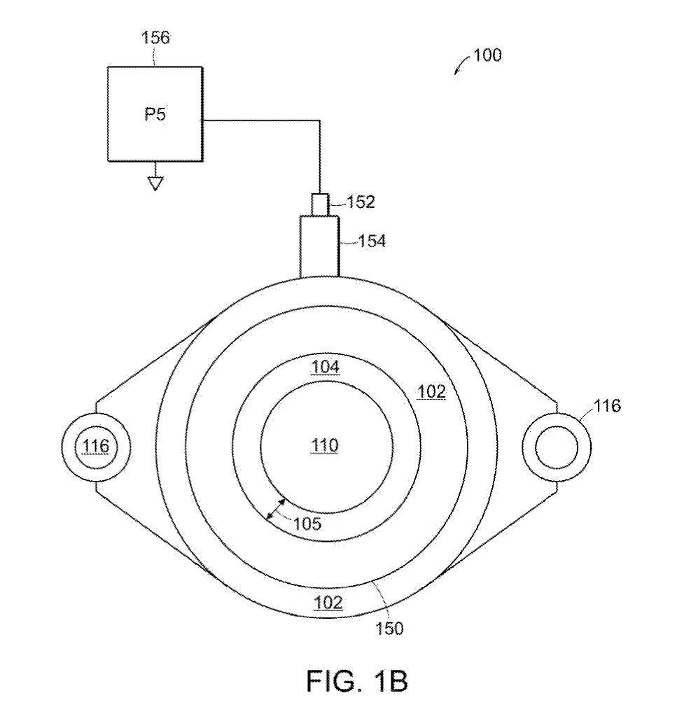

FIG. 2A illustrates a cross-sectional view of a second embodiment of a plasma assisted combustion device 200 according to the present invention. The second embodiment of the plasma assisted combustion device 200 is similar to the first embodiment of the plasma assisted combustion device 100. However, the ground and hot electrode structure of the plasma assisted combustion device 200 is different. The plasma assisted combustion device 200 includes a body 202 that defines a conical-shaped chamber 204 in a center region. The body 202 is typically formed of a high-dielectric strength material that prevents undesirable electrical discharges.

The particular shape of the conical-shaped chamber 204 is important. The cone angle of the conical-shaped chamber 204 is typically designed to be larger than the angle in which fuel is injected into the chamber 204. The cone angle of the conical-shaped chamber 204 can be chosen to maximize the space that the engine intake manifold can utilize to provide fuel. Thus, in some embodiments, the angle of the conical-shaped chamber 204 is chosen to fit the particular space where fuel can be injected. In one embodiment of the invention, the angle of the conical-shaped chamber 204 is chosen to improve the performance of a particular engine design.

For example, plasma assisted combustion devices according to the present invention that are designed to be used with turbine engines tend to have conical-shaped chambers 204 with relatively large cone angles because it is desirable to disperse fuel for turbine engines over a relatively large angle. In one particular embodiment, the angle of the conical-shaped chamber 204 is about 90 degrees. In contrast, plasma assisted combustion devices according to the present invention that are designed to be used with gasoline engines tend to have conical-shaped chambers 204 with somewhat narrower cone angles compared with turbine engines because gasoline is typically sprayed into the conical-shaped chambers 204 at a more narrow angle. In one particular embodiment, the angle of the conical-shaped chamber 204 for a gasoline engine is less than 90 degrees.

The plasma assisted combustion device 200 can be dimensioned to provide both a sufficient high voltage breakdown resistance necessary to prevent undesirable arcing and a physical size and volume that fit into common types of engines. A relatively small shape and volume is achieved, at least in part, by using a body 202 formed of a high-dielectric strength ceramic material.

For example, in one embodiment, the high dielectric strength material forming the body 202 is a glass/mica machinable ceramic, such as the Macor® machinable glass ceramic. The high-dielectric strength material forming the body 202 can also be alumina, porcelain, glass, a high-temperature plastic, such as Teflon®, a polyimide, or a polyamide. Other types of high-dielectric strength materials, such as some dielectrics commonly used in electronic capacitors, are suitable. For example, the high-dielectric strength material can be one of two high-dielectric strength materials manufactured under the DuPont Company trade name of Mylar® and Kapton®. In addition, some high temperature rubber compounds can be used for the high-dielectric strength material.

The plasma assisted combustion device 200 also includes a “hot” (high voltage) electrode 206 that is positioned around the conical-shaped chamber 204 defined by the body 202 in a groove 208 that is cut or formed in the body 202. The hot electrode 206 is a high voltage electrode that is formed of a high conductivity material. During normal operation, the hot electrode 206 is energized with a high DC voltage, such as a DC voltage of approximately 10 kV AC. In various embodiments, numerous other voltages and electrical waveshapes are used. The hot electrode 206 is shielded with a dielectric material, such as a ceramic potting material that is positioned in the groove 208. The dielectric material is positioned to reduce or minimize the probability of creating an undesirable electrical discharge to ground.

The plasma assisted combustion device 200 also includes a ground electrode 210 that enters from one side and turns downward towards the axis of the conical-shaped chamber 204 at a right angle. The ground electrode 210 can significantly enhance the electric field generated in the conical-shaped plasma chamber 204 compared with other designs. In one embodiment, the ground electrode 210 is positioned coaxial with and in the center of the conical-shaped chamber 204 so as to create a uniform electric field in the conical-shaped chamber 204 when energized. The uniform electric field creates a uniform plasma density in the conical-shaped chamber 204, which results in more uniform combustion.

The distance 211 that the tip of the ground electrode 210 is positioned above the bottom of conical-shaped chamber 204 is an important parameter. The desired distance 211 that the tip of the ground electrode 210 is positioned above the bottom of conical-shaped chamber 204 is generally a function of the cone angle of the conical-shaped chamber 204. In various embodiments, the distance 211 is chosen to achieve certain performance goals. For example, the distance 211 can be chosen to reduce the probability of an occurrence of an undesirable discharge from the hot electrode 206 to the ground electrode 210. Also, the distance 211 can be chosen to concentrate the electric field and thus the resulting plasma is a particular area within the conical-shaped chamber 204.

The ground electrode 210 can be formed of a stainless steel alloy, tungsten, a tungsten alloy, or one of a number of other refractory metals and refractory metal alloys that are resistant to erosion in a plasma environment. In addition, the ground electrode 210 can be formed of a carbon-based composite material. For example, the ground electrode 210 can be formed of a carbon nanotube material, or a graphitic surface material. Such materials are particularly resistant to erosion in plasma environments.

The ground electrode 210 is attached to the top of the body 202 with an electrode plate 212. The electrode plate 212 is much simpler and occupies less space compared with the support structure described in connection with the plasma assisted combustion device 100 of FIGS. 1A and 1B. The plasma assisted combustion device 200 can be significantly shorter in length compared with the plasma assisted combustion device 100.

A fuel injector 214 is positioned below the conical-shaped chamber 204 so as to provide a spray of fuel into the chamber 204 when activated. In the embodiment shown in FIG. 2A, a nylon spacer 216 is used to support and position the fuel injector 214. Suitable fuel injectors are commercially available from manufacturers, such as Delphi and Bosch. Other manufactures sell suitable fuel injectors for aircraft and watercraft. The fuel injector 214 converts a liquid fuel into a dispersed mist, vapor, or aerosolized fuel for combustion. The hot electrode 206, ground electrode 210, and the fuel injector 214 are positioned so that there is a seam-free barrier to “line of sight” electrical discharges from the hot electrode 206 to the ground electrode 210 and to the fuel injector 214.

FIG. 2B illustrates a top-view of the plasma assisted combustion device 200 described in connection with FIG. 2A. The top view of the plasma assisted combustion device 200 shows some features described in connection with FIG. 2A, such as the ground electrode 210 and the mounting plate 212. In addition, the top view of the plasma assisted combustion device 200 shows mounting holes 220 that can be used to secure the mounting plate to the body 202.

The second embodiment of the plasma assisted combustion device 200 has numerous desirable features. For example, the plasma assisted combustion device 200 can be fabricated in a highly compact package because it can be significantly shorter in length than the plasma assisted combustion device 100. One feature of the plasma assisted combustion device 200 is that it can have a shape and a volume that fits in most commonly used internal combustion engine. Also, the plasma assisted combustion device 200 has a simpler design with fewer parts and, therefore, can be easier and less expensive to manufacture.

In addition, the second embodiment of the plasma assisted combustion device 200 can achieve enhanced fuel flow compared with the first embodiment because there are minimal obstructions to the fuel flow through the plasma chamber 204. Also, the plasma assisted combustion device 200 can be highly efficient. Essentially all of the fuel in the plasma chamber 204 can be directly exposed to the plasma in order to enhance the probability of cracking the fuel. In contrast, devices that include conical-shaped ground electrodes that are formed of a wire mesh material may not expose all or even a high fraction of the fuel to the plasma, which can lower the efficiency of the combustion. These desirable features make the second embodiment of the plasma assisted combustion device 200 particularly well suited for use with turbine engines which combust kerosene based fuels. Kerosene based fuels condense more readily than many other fuels, so it is important to expose as much of the fuel to the plasma as possible to increase the probability of cracking the fuel and thus, the efficiency of the combustion.

Experiments using the second embodiment of the plasma assisted combustion device 200 indicate that the plasma density in this device is relatively high compared with the plasma density achieved with the first embodiment. In addition, the plasma utilization was relatively high. The term “plasma utilization” is defined herein as the ratio of the plasma volume to the volume of the plasma chamber. Also, the cracking efficiency achieved with the plasma assisted combustion device 200 was measured to be three to five times greater than the cracking efficiency of the first embodiment of the plasma assisted combustion device 100. Furthermore, experiments have shown that the power consumption is relatively low.

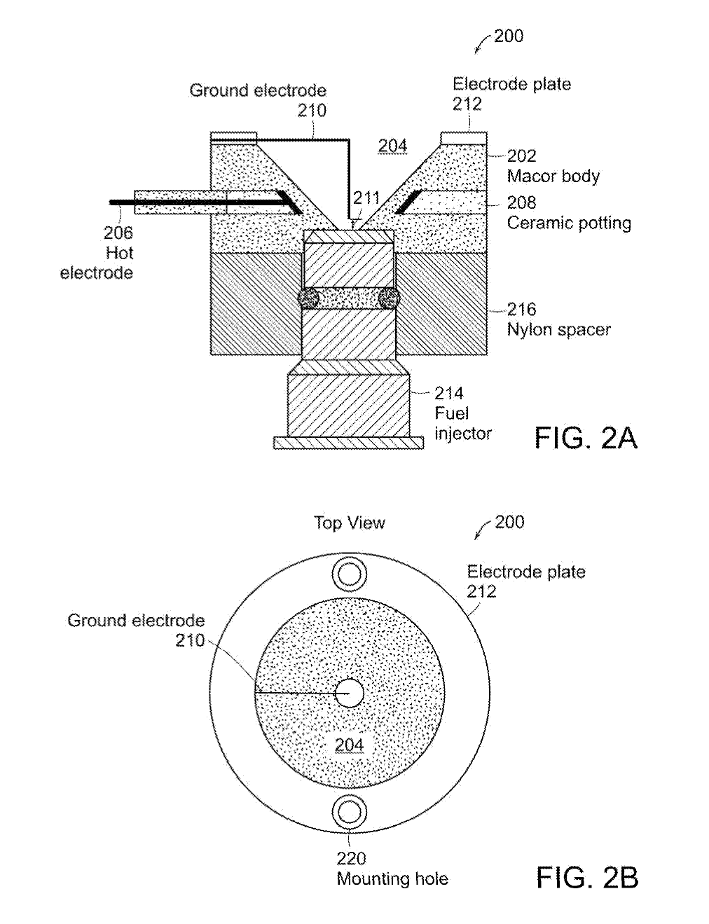

FIG. 3 illustrates a top-view of an array of plasma assisted combustion devices 300 according to the present invention. In practice, some turbine engines and other apparatus using the plasma assisted combustion device of the present invention will include an array of one or more of the plasma assisted combustion devices shown in FIGS. 1A, 1B, 2A and 2B. In the embodiment shown in FIG. 3, the array 300 includes a plurality of plasma assisted combustion devices configured in a circular pattern. The circular pattern provides a relatively high density of combustion surface and is suitable for many turbine engine designs. The injector interfaces and the mounting brackets are dependent on the particular engine designs.

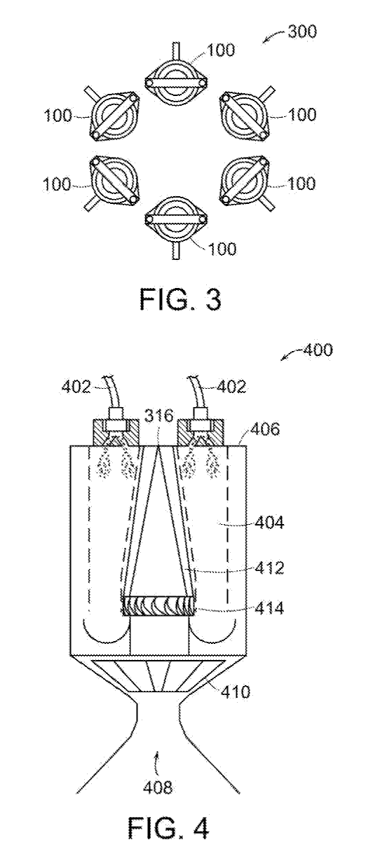

FIG. 4 illustrates a cross-section of a turbine engine 400 that uses the plasma assisted combustion device of the present invention. A turbine engine similar to the one illustrated in FIG. 4 is manufactured by Turbine Technologies of Chetek, Wis. It is understood that the turbine engine 400 is shown only to illustrate the present invention and that there are numerous other configurations of turbine engines and other types of engines that are compatible with the plasma assisted combustion device of the present invention.

The cross section of the turbine engine 400 shows two plasma combustion devices 402 according to the present invention, such as the plasma combustion devices 100, 200 that are described in connection with FIGS. 1A, 1B, 2A and 2B. This particular engine includes six plasma combustion devices that are positioned in a radial pattern around a circular combustion chamber 404. However, different engine designs can include any number of plasma combustion devices. The plasma combustion devices 402 are mounted on an end plate 406 at the exhaust end of the engine 400 so that the plasma chamber 104 (FIG. 1) faces the inside of the combustion chamber 404.

The turbine engine 400 includes an air intake 408 at the intake end of the engine. The air intake 408 funnels air into the engine for combustion. A compressor 410 is positioned between the air intake 408 and the combustion chamber 404. The compressor 410 compresses the air flowing through the air intake 408 and feeds the compressed air into the combustion chamber 404. Compressing the air increases the combustion efficiency of the engine.

The combustion chamber 404 mixes the plasma cracked fuel, including the free radical species, generated by the plasma combustion devices 402 with the air flowing into the air intake 408 that is compressed by the compressor 410 and then the mixture is ignited. A turbine 412 is positioned in the center of the engine 400. The turbine 412 includes fins 414 that are exposed to the gasses generated by the ignited fuel/air mixture. Ducts or conduits provide flow paths to transport the ignited fuel/air mixture to the fins 414 on the turbine 412. There are numerous possible combustion chamber and flow path designs. An engine exhaust 416 is positioned at the exhaust end of the engine to expel the gases generated by the combustion.

### Equivalents

While the present teachings are described in conjunction with various embodiments and examples, it is not intended that the present teachings be limited to such embodiments. On the contrary, the present teachings encompass various alternatives, modifications and equivalents, as will be appreciated by those of skill in the art, may be made therein without departing from the spirit and scope of the invention.

What is claimed is:

1. A plasma assisted combustion device comprising:
a) a body formed of a dielectric material that defines a conical-shaped plasma chamber;
b) a ground electrode that is positioned coaxial with the conical-shaped plasma chamber;
c) a hot electrode that is positioned proximate to the plasma chamber, the hot electrode being energized with a high voltage that strikes a plasma discharge in a gap between the ground electrode and an outer surface of the plasma chamber; and
d) a fuel injector that is positioned proximate to the conical chamber, the fuel injector having a nozzle that converts a liquid fuel into an aerosolized high molecular weight fuel that sprays into the plasma chamber, the plasma in the gap cracking the aerosolized high molecular weight fuel into at least some lower molecular weight fuel and activating at least some free radicals.

2. The plasma assisted combustion device of claim 1 wherein the ground electrode is suspended from the body.

3. The plasma assisted combustion device of claim 1 wherein the ground electrode is centered over the conical-shaped plasma chamber.

4. The plasma assisted combustion device of claim 1 wherein the ground electrode is positioned over the conical-shaped plasma chamber so that substantially all of a fuel injected into the conical-shaped plasma chamber is exposed to the plasma generated in the conical-shaped plasma chamber.

5. The plasma assisted combustion device of claim 1 wherein the ground electrode is shaped to locally increase an electric field generated by the hot electrode so as to reduce a probability of generating an undesirable electrical discharge in the conical-shaped plasma chamber.

6. The plasma assisted combustion device of claim 1 wherein the ground electrode is positioned above the conical-shaped plasma chamber a distance that is chosen to reduce a probability of generating an undesirable electrical discharge in the conical-shaped plasma chamber.

7. The plasma assisted combustion device of claim 1 wherein the ground electrode is positioned above the conical-shaped plasma chamber a distance that is chosen to concentrate an electric field in a predetermined area within the conical-shaped plasma chamber.

8. The plasma assisted combustion device of claim 1 wherein the ground electrode is positioned above the conical-shaped plasma chamber a distance that is related to an angle of the conical-shaped plasma chamber.

9. The plasma assisted combustion device of claim 1 wherein an angle of the conical-shaped plasma chamber is greater than an angle in which fuel is injected into the conical-shaped plasma chamber.

10. The plasma assisted combustion device of claim 1 wherein an angle of the conical-shaped plasma chamber is chosen to improve combustion efficiency.

11. The plasma assisted combustion device of claim 1 wherein the hot electrode is positioned around the body in a groove formed in the body.

12. The plasma assisted combustion device of claim 1 wherein the body is formed of a ceramic material.

13. The plasma assisted combustion device of claim 1 wherein the ground electrode is formed of a solid conducting material.

14. The plasma assisted combustion device of claim 1 further comprising a structure that increases a discharge path length from the plasma to the ground electrode.

15. The plasma assisted combustion device of claim 1 further comprising a power supply having an output that is electrically connected to the hot electrode, the power supply generating a high voltage that energizes the hot electrode so as to form the plasma.

16. The plasma assisted combustion device of claim 1 further comprising a combustion chamber coupled to the plasma chamber so that the lower molecular weight fuel and free radicals are injected into the combustion chamber.

17. The plasma assisted combustion device of claim 1 further comprising a ceramic compound that is positioned around the hot electrode so as to insulate the hot electrode from the ground electrode.

18. A method of plasma assisted combustion, the method comprising:
a) suspending a ground electrode in a plasma chamber so as to form a gap between the ground electrode and an outer surface of the plasma chamber;
b) energizing a hot electrode positioned proximate to the plasma chamber with a high voltage that strikes a plasma discharge in the gap between the ground electrode and the outer surface of the plasma chamber;
c) injecting aerosolized high molecular weight fuel into the gap between the ground electrode and the outer surface of the plasma chamber, the plasma in the gap cracking the aerosolized high molecular weight fuel into lower molecular weight fuel and activating free radicals;
d) mixing the lower molecular weight fuel and free radicals with air; and
e) igniting the mixture of lower molecular weight fuel, free radicals, and air.

19. The method of claim 18 further comprising shielding at least one of the hot electrode and the ground electrode with a high dielectric ceramic material that reduces the probability of generating an undesirable electric discharge.

20. The method of claim 18 further comprising positioning at least one of the hot electrode and the ground electrode to reduce a probability of generating an undesirable electric discharge.

21. The method of claim 18 further comprising positioning at least one of the hot electrode and the ground electrode to increase a probability of striking the plasma discharge.

22. The method of claim 18 wherein at least one of the voltages applied to the hot electrode, dimensions of the gap, and the amount of air mixed with the lower molecular weight fuel and the free radicals are chosen to improve fuel efficiency.

23. The method of claim 18 wherein at least one of the voltages applied to the hot electrode, dimensions of the gap, and the amount of air mixed with the lower molecular weight fuel and the free radicals are chosen to maximize fuel efficiency.

24. The method of claim 18 wherein at least one of the voltages applied to the hot electrode, dimensions of the gap, and the amount of air mixed with the lower molecular weight fuel and the free radicals are chosen minimize undesirable emissions.

25. The method of claim 18 further comprising creating a locally intense electric field proximate to at least one of the hot electrode and the ground electrode in order to increase a probability of striking a plasma.

26. The method of claim 18 further comprising compressing the air that is mixed with the lower molecular weight fuel and free radicals.

27. An internal combustion engine comprising:
a) a plasma assisted combustion fuel injector comprising a body formed of a dielectric material that defines a conical-shaped plasma chamber; a ground electrode comprising a ground electrode that is positioned in the plasma chamber; a hot electrode that is positioned proximate to the plasma chamber; and a fuel injector that is positioned proximate to the conical chamber so as to inject aerosolized high molecular weight fuel into the plasma chamber;
b) a power supply having an output that is electrically connected to the hot electrode, the power supply generating a high voltage that energizes the hot electrode so as to form a plasma discharge in the plasma chamber that cracks the aerosolized high molecular weight fuel into lower molecular weight fuel and that activates free radicals;
c) a combustion chamber being coupled to the plasma chamber so that the lower molecular weight fuel and free radicals are injected into the combustion chamber, the combustion chamber comprising an air intake that receives air that mixes with the lower molecular weight fuel and free radicals; and
d) an ignition source that ignites the air and lower molecular weight fuel and free radicals mixture.

28. The engine of claim 27 wherein the internal combustion engine comprises a turbine engine.

29. The engine of claim 27 wherein at least one of the voltage applied to the hot electrode, dimensions of the plasma chamber, and dimensions of the combustion chamber are chosen to improve fuel efficiency.

30. The engine of claim 27 wherein at least one of the voltage applied to the hot electrode, dimensions of the plasma chamber, and dimensions of the combustion chamber are chosen to maximize fuel efficiency.

31. The engine of claim 27 wherein at least one of the voltage applied to the hot electrode, dimensions of the plasma chamber, and dimensions of the combustion chamber are chosen to reduce undesirable emissions.

32. The engine of claim 27 wherein at least one of the voltage applied to the hot electrode, dimensions of the plasma chamber, and dimensions of the combustion chamber are chosen to minimize undesirable emissions.
